(19) United States
(12) Patent Application Publication
(10) Pub. No.: US 2025/0055375 A1
(43) Pub. Date: Feb. 13, 2025

(54) SEMICONDUCTOR DEVICE AND SWITCHING POWER SUPPLY

(71) Applicant: ROHM CO., LTD., Kyoto (JP)

(72) Inventor: Kenichi OKAJIMA, Kyoto (JP)

(21) Appl. No.: 18/932,128

(22) Filed: Oct. 30, 2024

Related U.S. Application Data
(63) Continuation of application No. PCT/JP2023/012462, filed on Mar. 28, 2023.

(30) Foreign Application Priority Data
May 18, 2022 (JP) 2022-081393

(51) Int. Cl. H02M 3/158; H02M 1/08

(52) U.S. Cl. CPC H02M 3/1588; H02M 1/08

(57) ABSTRACT

A semiconductor device includes: a first driver that drives an output element constituting a switching output stage; at least a part of a bootstrap circuit that generates a boot voltage higher than a switching voltage output from the switching output stage and feed the boot voltage to the first driver; and a boot voltage detection circuit that charges the boot voltage on sensing, with the output element off, the difference between the boot voltage and the switching voltage becoming lower than a lower-limit detection value. The boot voltage detection circuit senses the boot voltage through resistance voltage division if a rectification element constituting together with the output element the switching output stage is on, and senses the boot voltage through capacitance voltage division if the rectification element is off.

### CROSS-REFERENCE TO RELATED APPLICATIONS

This nonprovisional application is a continuation application of International Patent Application No. PCT/JP2023/012462 filed on Mar. 28, 2023, which claims priority to Japanese Patent Application No. 2022-081393 filed on May 18, 2022, the entire contents of which are hereby incorporated by reference.

### TECHNICAL FIELD

The present disclosure relates to a semiconductor device and to a switching power supply employing a semiconductor device.

### BACKGROUND ART

Bootstrap circuits are commonly and widely used as a means for internal power supply to drive an N-channel output transistor.

One example of known technologies related to what has just been mentioned is seen in Patent Document 1 identified below.

### CITATION LIST

### Patent Literature

Patent Document 1: JP-A-2018-133916

### BRIEF DESCRIPTION OF DRAWINGS

FIG. 1 is a diagram showing an overall configuration of a switching power supply.

FIG. 2 is a diagram showing a switching power supply according to a first embodiment (comparative example).

FIG. 3 is a diagram showing switching operation (with Vb normal) in the first embodiment.

FIG. 4 is a diagram showing switching operation (with Vb falling) in the first embodiment.

FIG. 5 is a diagram showing a switching power supply according to a second embodiment.

FIG. 6 is a diagram showing switching operation in the second embodiment.

FIG. 7 is a diagram showing a switching power supply according to a third embodiment.

FIG. 8 is a diagram showing switching operation in the third embodiment.

FIG. 9 is a diagram showing a switching power supply according to a fourth embodiment.

FIG. 10 is a diagram showing switching operation in the fourth embodiment.

FIG. 11 is a diagram showing a switching power supply according to a fifth embodiment.

FIG. 12 is a diagram showing switching operation in the fifth embodiment.

### DESCRIPTION OF EMBODIMENTS

### Switching Power Supply (Overall Configuration)

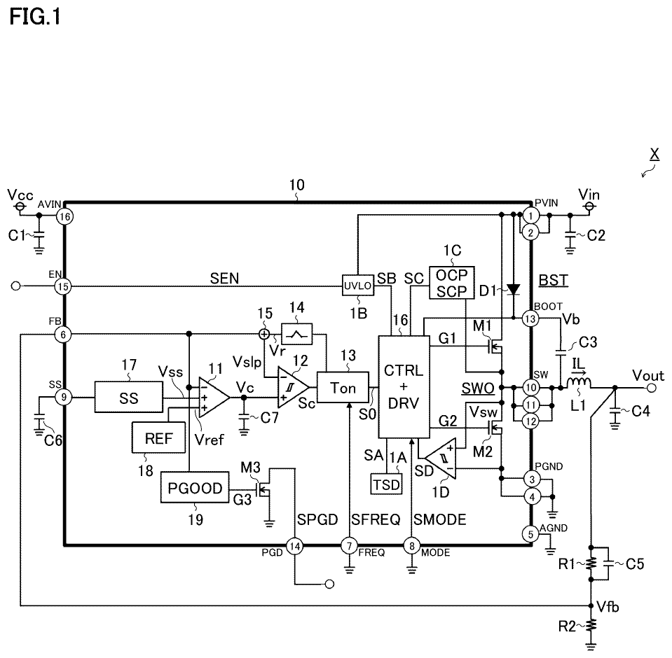

FIG. 1 is a diagram showing an overall configuration of a switching power supply. The switching power supply X of this configuration example is a buck (step-down) DC/DC converter that bucks an input voltage Vin to produce a desired output voltage Vout. In what is shown in the diagram, the switching power supply X includes a semiconductor device 10 and various discrete components externally connected to it (capacitors C1 to C6, an inductor L1, and resistors R1 and R2).

The semiconductor device 10 is the principal agent (what is called a power control IC (integrated circuit)) that comprehensively control the operation of the switching power supply X. The semiconductor device 10 has a plurality of external terminals (in the diagram, pin-1 to pin-16) as a means for establishing electrical connection with outside the device.

Pin-1 and pin-2 serve as a power-system supply terminal PVIN to which the input voltage Vin is applied. Pin-3 and pin-4 serve as a power-system ground terminal PGND. Pin-5 is an analog-system ground terminal AGND. Pin-6 is a feedback input terminal FB. Pin-7 is a frequency setting terminal FREQ. Pin-8 is a mode setting terminal MODE. Pin-9 is a soft-start setting terminal SS. Pin-10, pin-11, and pin-12 serve as a switching output terminal SW. Pin-13 is a bootstrap terminal BOOT. Pin-14 is a power-good output terminal PGD. Pin-15 is an enable input terminal EN. Pin-16 is an analog-system supply terminal AVIN.

Next, the interconnections outside the semiconductor device 10 will be described. The first terminal of the capacitor C1 is connected to the analog-system supply terminal AVIN. The second terminal of the capacitor C1 is connected to a ground terminal (e.g., the analog-system ground terminal AGND). The first terminal of the capacitor C2 is connected to the power-system supply terminal PVIN (i.e., an application terminal for the input voltage Vin). The second terminal of the capacitor C2 is connected to a ground terminal (e.g., the power-system ground terminal PGND). The first terminal of the capacitor C3 is connected to the bootstrap terminal BOOT. The second terminal of the capacitor C3 and the first terminal of the inductor L1 are both connected to the switching output terminal SW. The second terminal of the inductor L1 and the first terminals of the resistor R1 and the capacitors C4 and C5 are all connected to an application terminal for the output voltage Vout. The second terminals of the resistor R1 and the capacitor C5 and the first terminal of the resistor R2 are all connected to the feedback input terminal FB (i.e., an application terminal for a feedback voltage Vfb). The second terminals of the capacitor C4 and the resistor R2 are both connected to a ground terminal (e.g., the power-system ground terminal PGND). The first terminal of the capacitor C6 is connected to the soft-start setting terminal SS. The second terminal of the capacitor C6 is connected to a ground terminal (e.g., the analog-system ground terminal AGND).

### Semiconductor Device

Referring still to FIG. 1, the internal configuration of the semiconductor device 10 will be described in detail. The semiconductor device 10 of this configuration example includes, integrated in it, an error amplifier 11, a comparator 12, an on-time setting circuit 13, a ripple generation circuit 14, an adder circuit 15, a driving control circuit 16, a soft-start circuit 17, a reference voltage generation circuit 18, a power-good detection circuit 19, an overheat protection circuit 1A, a low-input protection circuit 1B, an overcurrent/short-circuit protection circuit 1C, a zero-cross detection circuit 1D, a capacitor C7, a diode D1, an output element M1, a synchronous-rectification element M2, and a transistor M3.

The error amplifier 11 generates an error voltage Vc corresponding to the difference between whichever is lower of a reference voltage Vref and a soft-start voltage Vss, which are respectively fed to the two non-inverting input terminals (+) of the error amplifier 11, and the feedback voltage Vfb, which is fed to the inverting input terminal (−) of the error amplifier 11. The error voltage Vc increases if the feedback voltage Vfb is lower than whichever is lower of the reference voltage Vref and the soft-start voltage Vss, and increases if the feedback voltage Vfb is higher than whichever is lower of the reference voltage Vref and the soft-start voltage Vss.

The comparator 12 generates a comparison signal Sc by comparing a slope voltage Vslp, which is fed to the inverting input terminal (−) of the comparator 12, and the error voltage Vc, which is fed to the non-inverting input terminal (+) of the comparator 12. The comparison signal Sc is at high level if the slope voltage Vslp is lower than the error voltage Vc, and is at low level if the slope voltage Vslp is higher than the error voltage Vc. The comparator 12 can be given hysteresis characteristics.

The on-time setting circuit 13 generates a control signal S0 so as to keep the output element M1 on for an on-time Ton after a rise of the comparison signal Sc to high level. The on-time setting circuit 13 can be given a function of setting a switching frequency fsw according to a frequency setting signal SFREG externally fed to the frequency setting terminal FREQ.

The ripple generation circuit 14 generates, in synchronization with the control signal S0, a ripple voltage Vr that simulates a ripple component in the output voltage Vout.

The adder circuit 15 generates the slope voltage Vslp by adding up the feedback voltage Vfb and the ripple voltage Vr.

The driving control circuit 16 carries out basic output feedback control by generating gate driving signals G1 and G2 so as to keep the output voltage Vout equal to a predetermined target value by a bottom-detection fixed-on-time scheme.

The driving control circuit 16 has a function of forcibly suspending the switching driving of each of the output element M1 and the synchronous-rectification element M2 according to an overheat protection signal SA, a low-input protection signal SB, and an overcurrent/short-circuit protection signal SC.

The driving control circuit 16 also has a function of suspending the switching driving of each of the output element M1 and the synchronous-rectification element M2 in a light-load condition according to a zero-cross detection signal SD. For example, the driving control circuit 16 can turn off the synchronous-rectification element M2 when with the output element M1 off and the synchronous-rectification element M2 on the zero-cross detection signal SD rises to high level, that is, when the switching voltage Vsw is sensed to be higher than a zero-cross detection value (e.g., PGND).

The driving control circuit 16 can further has a function of setting the operation mode of the semiconductor device 10 according to a mode setting signal SMODE externally fed to the mode setting terminal MODE.

The soft-start circuit 17 generates a soft-start voltage Vss that rises gently after the start-up of the semiconductor device 10. The time (soft-start time) that elapses after the soft-start voltage Vss starts rising until it becomes higher than the reference voltage Vref can be adjusted as desired according to the capacitance value of the capacitor C6 externally connected to the soft-start setting terminal SS.

The reference voltage generation circuit 18 generates the predetermined reference voltage Vref (corresponding to the target value of the feedback voltage Vfb and hence the target value of the output voltage Vout).

The power-good detection circuit 19 generates a gate driving signal G3 by sensing whether the feedback voltage Vfb is higher than a predetermined power-good detection threshold value.

The overheat protection circuit 1A generates the overheat protection signal SA by sensing whether the junction temperature Tj of the semiconductor device 10 (in particular, the output element M1 is higher than a predetermined overheat protection threshold value.

The low-input protection circuit 1B (what is called an UVLO (undervoltage lock-out circuit)) generates the low-input protection signal SB by sensing whether the input voltage Vin is higher than a predetermined low-input protection threshold value. The low-input protection circuit 1B is switched between an enabled and a disabled state according to an enable signal SEN externally fed to the enable input terminal EN.

The overcurrent/short-circuit protection circuit 1C generates the overcurrent/short-circuit protection signal SC by monitoring the switching voltage Vsw.

The zero-cross detection circuit 1D detects the zero-crossing (flow reversal) of an inductor current IL passing across the synchronous-rectification element M2 by monitoring the terminal-to-terminal voltage across the synchronous-rectification element M2 (corresponding to the switching voltage Vsw).

For example, the zero-cross detection circuit 1D can be implemented with, as shown in the diagram, a comparator with hysteresis that generates the zero-cross detection signal SD by comparing the switching voltage Vsw, which is fed to its non-inverting input terminal (+), with the ground voltage PGND, which is fed to its inverting input terminal (−). In that case, the zero-cross detection signal SD is at low level if Vsw<PGND, and is at high level if Vsw>PGND.

The capacitor C7 is connected, as a phase compensation means for preventing oscillation of the error amplifier 11, between the output terminal of the error amplifier 11 and a ground terminal (e.g., the analog-system ground terminal AGND).

The anode of the diode D1 is connected to the power-system supply terminal PVIN. The cathode of the diode D1 is connected to the bootstrap terminal BOOT. So connected, the diode D1 together with the capacitor C3 described above constitutes a bootstrap circuit BST. The bootstrap circuit BST generates a boot voltage Vb that is higher than the switching voltage Vsw by the terminal-to-terminal voltage across the capacitor C3 to feed the boot voltage Vb to the driving control circuit 16 (in particular, a driver 162, which will be described later). The diode D1 can be suitably implemented with a Schottky barrier diode.

The output element M1 (e.g., an NMOSFET (N-channel metal-oxide-semiconductor field-effect transistor)) functions as a high-side switch in a switching output stage SWO that generates the switching voltage Vsw from the input voltage Vin. The drain of the output element M1 is connected to the power-system supply terminal PVIN. The source of the output element M1 is connected to the switching output terminal SW. The gate of the output element M1 is connected to an application terminal for the gate driving signal G1. The output element M1 is on if the gate driving signal G1 is at high level, and is off if the gate driving signal G1 is at low level.

The synchronous-rectification element M2 (e.g., an NMOSFET) functions as a low-side switch in the switching output stage SWO. The drain of the synchronous-rectification element M2 is connected to the switching output terminal SW. The source of the synchronous-rectification element M2 is connected to the power-system ground terminal PGND. The gate of the synchronous-rectification element M2 is connected to an application terminal for the gate driving signal G2. The synchronous-rectification element M2 is on if the gate driving signal G2 is at high level, and is off if the gate driving signal G2 is at low level.

The rectifying element can be implemented with, instead of the synchronous-rectification element M2, a rectification diode (e.g., a Schottky barrier diode) of which the cathode is connected to the switching output terminal SW and of which the anode is connected to the power-system ground terminal PGND.

The output element M1 and the synchronous-rectification element M2 can be externally connected to the semiconductor device 10. In that case, in place of the switching output terminal SW are needed an external input terminal for the switching voltage Vsw and external output terminals for the gate driving signals G1 and G2 respectively.

In a case where a high voltage is applied to the switching output stage SWO, the output element M1 and the synchronous-rectification element M2 can be implemented with high-withstand-voltage devices such as IGBTs (insulated-gate bipolar transistor), SiC devices, or GaN devices.

The transistor M3 functions as an open-drain output stage. The drain of the transistor M3 is connected to the power-good output terminal PGD (i.e., an application terminal for a power-good signal SPGD). The source of the transistor M3 is connected to a ground terminal (e.g., the analog-system ground terminal AGND). The gate of the transistor M3 is connected to an application terminal for the gate driving signal G3. The transistor M3 is on if the gate driving signal G3 is at high level, and is off if the gate driving signal G3 is at low level.

### Switching Power Supply (First Embodiment)

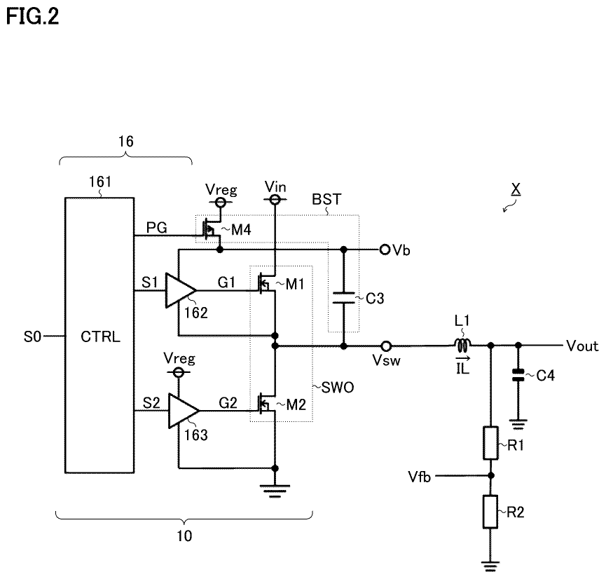

FIG. 2 is a diagram showing a switching power supply X according to a first embodiment (as a comparative example to be compared with the first to fifth embodiments described later). The switching power supply X of this embodiment is based on the overall configuration (FIG. 1) described previously and includes a modified bootstrap circuit BST.

In what is shown in the diagram, the bootstrap circuit BST includes, instead of the diode D1 described previously, a transistor M4 (e.g., a PMOSFET (P-channel MOSFET)). The source of the transistor M4 is connected to an application terminal for an internal supply voltage Vreg. The drain of the transistor M4 is connected to an application terminal for the boot voltage Vb. The gate of the transistor M4 is connected to an application terminal for a gate driving signal PG. The transistor M4 is off if the gate driving signal PG is at high level, and is on if the gate driving signal PG is at low level.

In the bootstrap circuit BST of this configuration example, the capacitor C3 is incorporated in the semiconductor device 10. This helps reduce the number of discrete components that are externally connected to the semiconductor device 10. However, as compared with a configuration where the capacitor C3 is externally connected to the semiconductor device 10, the capacitor C3 has a lower capacitance value. This necessitates a study on a measure against a fall of the boot voltage Vb (details will be given later).

The diagram shows, as specific components of the driving control circuit 16, a controller 161 and drivers 162 and 163.

The controller 161 carries out basic output feedback control by generating gate control signals S1 and S1 so as to keep the output voltage Vout equal to a predetermined target value by a bottom-detection fixed-on-time scheme.

The controller 161 generates the gate driving signal PG as a control signal for the bootstrap circuit BST. The gate driving signal PG is basically the logically inverted signal of the gate control signal S2. Specifically, the gate driving signal PG is at low level if the gate control signal S2 is at high level, and is at high level if the gate control signal S2 is at low level. That is, the transistor M4 is on when the synchronous-rectification element M2 is on, and is off when the synchronous-rectification element M2 is off.

The driver 162 drives the output element M1 by generating the gate driving signal G1 according to the gate control signal S1. For example, the gate driving signal G1 is at high level (=Vb) if the gate control signal S1 is at high level, and is at low level (=Vsw) if the gate control signal S1 is at low level. In this way, the driver 162 operates by being supplied with the boot voltage Vb and can turn on the output element M1 reliably.

The driver 163 drives the synchronous-rectification element M2 by generating the gate driving signal G2 according to the gate control signal S2. For example, the gate driving signal G2 is at high level (=Vreg) if the gate control signal S2 is at high level, and is at low level (=PGND) if the gate control signal S2 is at low level.

The switching output stage SWO turns on and off the output element M1 and the synchronous-rectification element M2, which are connected so as to constitute a half bridge, complimentarily and thereby generates a switching voltage Vsw that is pulse-driven between the input voltage Vin and the ground voltage PGND.

In the present description, the term “complementarily” covers not only operation in which the on/off states of the output element M1 and the synchronous-rectification element M2 are completely reversed but also operation in which their on/off transitions are delayed (i.e., a simultaneously-off period is provided).

The inductor L1 and the capacitor C4 function as an LC filter that rectifies and smooths the switching voltage Vsw with a rectangular wave form to produce the output voltage Vout.

The resistors R1 and R2 function as a feedback voltage generation circuit (voltage division circuit) that outputs from the connection node between them a feedback voltage Vfb corresponding to the output voltage Vout (i.e., a division voltage of the output voltage Vout). Though not specifically shown in the diagram, a speeding-up capacitor C5 (see FIG. 1) can be connected in parallel with the resistor R1, across its terminals, for smooth start-up of the switching power supply X. In a case where the output voltage Vout falls within the input dynamic range of the semiconductor device 10, the resistors R1 and R2 can be omitted and the output voltage Vout can be fed directly to the feedback input terminal FB.

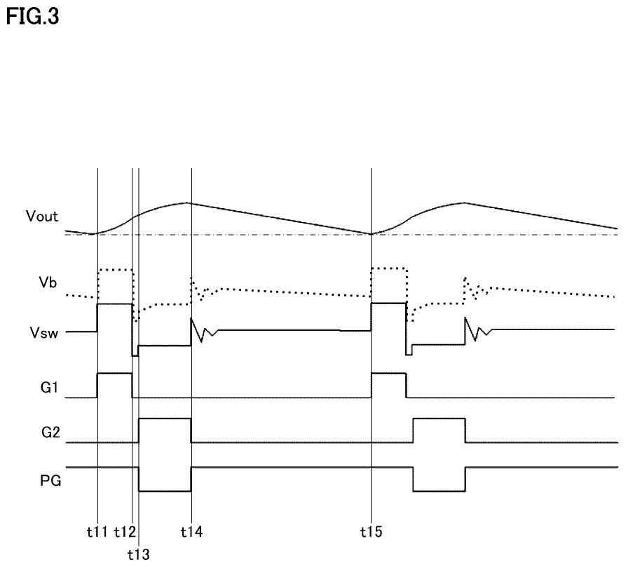

FIG. 3 is a diagram showing the switching operation (with the boot voltage Vb normal) in the first embodiment, depicting, from top down, the output voltage Vout, the switching voltage Vsw (solid line) and the boot voltage Vb (broken line), and gate driving signals G1, G2, and PG. The diagram shows intermittent switching operation wave forms in a light-load condition.

As observed between times t11 and t12, when the gate driving signal G1 is at high level and the gate driving signal G2 is at low level, the output element M1 is on and the synchronous-rectification element M2 is off. Accordingly, the inductor current IL passes in the direction leading from the power-system supply terminal PVIN (i.e., an application terminal for the input voltage Vin) via the output element M1 and the inductor L1 to an application terminal for the output voltage Vout. As a result, the output voltage Vout rises. The switching voltage Vsw is at high level (=Vin−IL×Ron(M1), where Ron(M1) is the on-resistance of the output element M1).

When the gate driving signal G2 is at low level, the gate driving signal PG is at high level, and thus the transistor M4 in the bootstrap circuit BST is off. Accordingly, the boot voltage Vb has a voltage value hither than the switching voltage Vsw by the terminal-to-terminal voltage across the capacitor C3.

By contrast, as observed between times t13 and t14, when the gate driving signal G1 is at low level and the gate driving signal G2 is at high level, the output element M1 is off and the synchronous-rectification element M2 is on. In this state, the inductor L1, with an electromotive force induced in it, lets the inductor current IL keep passing in the same direction as before. That is, the inductor current IL keeps passing in the direction leading from the power-system ground terminal PGND via the synchronous-rectification element M2 and the inductor L1 to the application terminal for the output voltage Vout. As a result, the output voltage Vout continues to rise. The switching voltage Vsw is at low level (=PGND−IL×Ron(M2), where Ron(M2) is the on-resistance of the synchronous-rectification element M2.

When the gate driving signal G2 is at high level, the gate driving signal PG is at low level, and thus the transistor M4 in the bootstrap circuit BST is on. Accordingly, a current that passes from the application terminal for the internal supply voltage Vreg via the transistor M4 charges the capacitor C3, and thus the boot voltage Vb rises.

After that, at time t14, when the electromotive force in the inductor L1 becomes so low that a zero-crossing of the inductor current IL passing across the synchronous-rectification element M2 is detected, the gate driving signal G2 is dropped from high level to low level. As a result, the output element M1 and the synchronous-rectification element M2 both remain off, leaving the switching output terminal SW in a high-impedance state. Here, the switching voltage Vsw is nearly equal to the output voltage Vout.

When the gate driving signal G2 is dropped to low level, the gate driving signal PG is raised to high level, and thus the transistor M4 in the bootstrap circuit BST turns off. Accordingly, in the driving suspension period of the switching output stage SWO (i.e., between times t14 and t15), the boot voltage Vb is kept at a voltage value higher than the switching voltage Vsw by the terminal-to-terminal voltage across the capacitor C3. However, if Vb+Vf>Vreg (where Vf is the forward drop voltage across the body diode that accompanies the transistor M4), the capacitor C3 is not charged. Thus, in the driving suspension period of the switching output stage SWO, the boot voltage Vb falls through spontaneous discharging.

When at time t15 the output voltage Vout (and hence the feedback voltage Vfb) falls down to the bottom detection value, the gate driving signal G1 is raised to high level, and thus the output element M1 turns on. As a result, the output voltage Vout starts to rise back.

As shown in the diagram, so long as the fall of the boot voltage Vb in the driving suspension period of the switching output stage SWO (i.e., between times t14 and t15) is small, it does not impair the on-transition of the output element M1 at time t15.

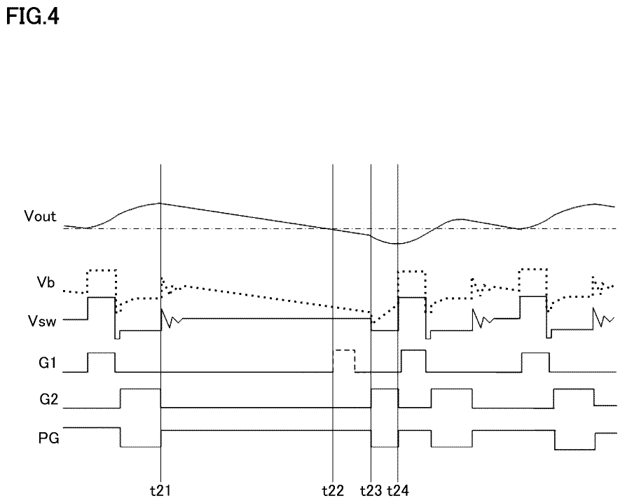

FIG. 4 is a diagram showing the switching operation (with the boot voltage Vb falling) in the first embodiment, depicting, like FIG. 3 referred to previously, from top down, the output voltage Vout, the switching voltage Vsw (solid line) and the boot voltage Vb (broken line), and gate driving signals G1, G2, and PG. This diagram too shows intermittent switching operation wave forms in a light-load condition.

As opposed to FIG. 3 referred to previously, however, this diagram depicts the behavior observed if the fall of the boot voltage Vb in the driving suspension period of the switching output stage SWO (i.e., between times t21 and t22) is relatively large. In this case, when at time t22 the output voltage Vout is sensed to have fallen down to the bottom detection value, the terminal-to-terminal voltage across the capacitor C3 (=Vb−Vsw) may be lower than the on threshold value of the output element M1. In this condition, the gate driving signal G1 does not rise sufficiently, preventing the output element M1 from turning on.

If the gate driving signal G1 is not sensed to rise, as observed between times t23 and t24, the gate driving signal G2 is raised to high level and the gate driving signal PG is dropped to low level. As a result, the capacitor C3 is charged and the boot voltage Vb rises. Thus, at time t24, the gate driving signal G1 can be raised the high level so that the output element M1 is turned on.

However, the sequence of reboot operation described above is performed in response to the gate driving signal G1 not rising sufficiently, and thus the on-timing of the output element M1 comes later than is supposed to (delayed from time t22 to time t24). Hence, the output voltage Vout falls to lower than the bottom detection value.

Moreover, if with the boot voltage Vb not high enough the synchronous-rectification element M2 is turned on, due to the insufficient capacity of the driver 162, as the switching voltage Vsw falls, the gate-source voltage of the output element M1 may rise. As a result, not only the synchronous-rectification element M2 but also the output element M1 may turn on and an excessive through current may pass across the switching output stage SWO.

In a case where the capacitor C3 is incorporated in the semiconductor device 10, it is difficult to give the capacitor C3 a sufficient capacitance value. Thus, in the driving suspension period of the switching output stage SWO, the boot voltage Vb exhibits a relatively large fall. This tends to make the above problem notable.

The above problem is observed also where the switching output stage SWO employs a diode rectification scheme.

Presented below is an embodiment devised to solve the above problem.

### Switching Power Supply (Second Embodiment)

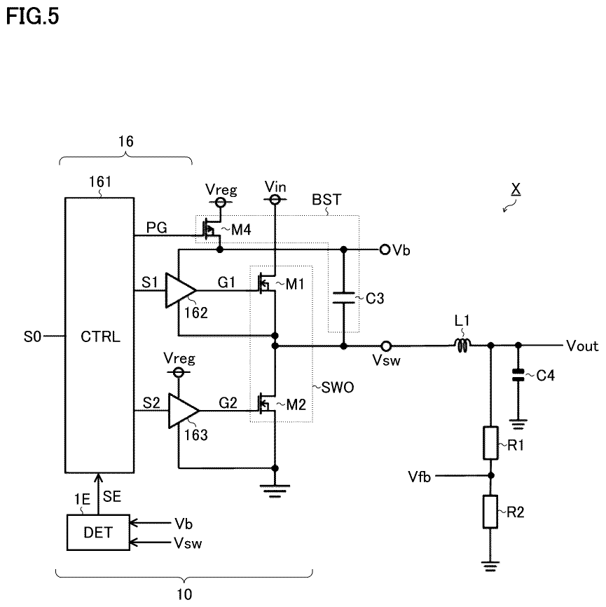

FIG. 5 is a diagram showing a switching power supply X according to a second embodiment. The switching power supply X of this embodiment is based on the first embodiment (FIG. 2) described previously and further includes a boot voltage detection circuit 1E.

The boot voltage detection circuit 1E generates a reboot control signal SE so as to charge the boot voltage Vb on sensing, with the output element M1 off, the difference (Vb−Vsw) between the boot voltage Vb and the switching voltage Vsw becoming lower than a lower-limit detection value.

For example, the reboot control signal SE is at low level (i.e., the logic level corresponding to BOOTVULO not being detected) if the difference (Vb−Vsw) is higher than the lower-limit detection value, and is at high level (i.e., the logic level corresponding to BOOTVULO being detected) if the (Vb−Vsw) is lower than the lower-limit detection value.

In the driving suspension period of the switching output stage SWO, when the reboot control signal SE rises to high level, the controller 161 turns on the synchronous-rectification element M2 and the transistor M4 to charge the boot voltage Vb.

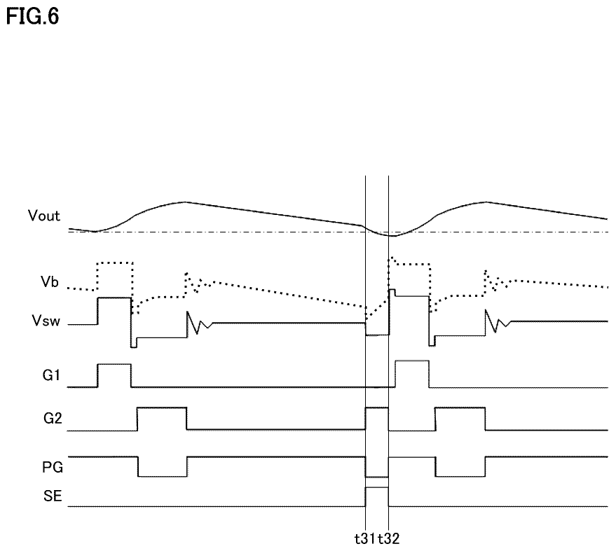

FIG. 6 is a diagram showing the switching operation in the second embodiment, depicting, from top down, the output voltage Vout, the switching voltage Vsw (solid line) and the boot voltage Vb (broken line), the gate driving signals G1, G2, and PG, and the reboot control signal SE. This diagram too shows intermittent switching operation wave forms in a light-load condition.

In the driving suspension period of the switching output stage SWO (G1=G2=L), the boot voltage Vb falls and when at time t31 the difference (Vb−Vsw) between the boot voltage Vb and the switching voltage Vsw becomes lower than the lower-limit detection value, the reboot control signal SE rises to high level. Consequently, as observed between times t31 and t32, the gate driving signal G2 is raised to high level and the gate driving signal PG is dropped to low level. As a result, the capacitor C3 is charged and the boot voltage Vb rises. It is thus possible to raise the boot voltage Vb sufficiently before a turn-on of the output element M1.

Note that, between times t31 and t32, the synchronous-rectification element M2 is kept on to charge to capacitor C3 and thus, as in the first embodiment described previously (FIG. 4, between times t13 and t14), the output voltage Vout falls. However, here, unlike in the first embodiment (FIG. 4) described previously, the sequence of reboot operation described above is performed not in response to a failed on-transition of the output element M1 but without delay when the difference (Vb−Vsw) between the boot voltage Vb and the switching voltage Vsw becomes lower than the lower-limit detection value. Thus, the on-timing of the output element M1 is less likely to be delayed than in the first embodiment (FIG. 4) described previously, and this reduces the fall in the output voltage Vout.

### Switching Power Supply (Third Embodiment)

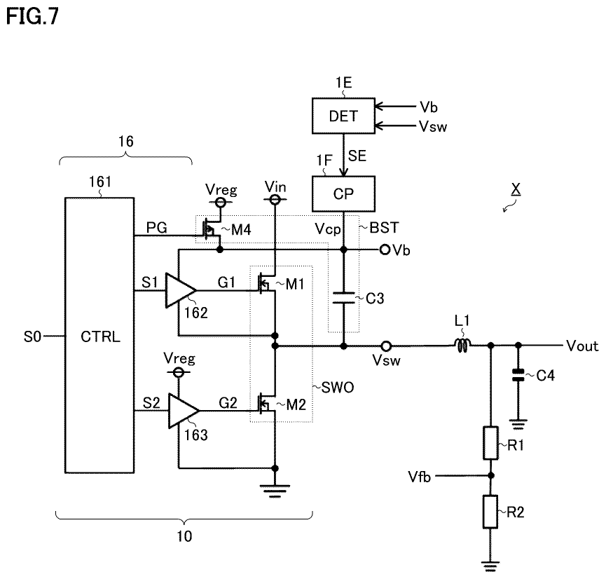

FIG. 7 is a diagram showing a switching power supply X according to a third embodiment. The switching power supply X of this embodiment is based on the second embodiment (FIG. 5) described previously and further includes a charge pump 1F.

The charge pump 1F generates, according to the reboot control signal SE, a boosted voltage Vcp higher than the input voltage Vin and feeds the boosted voltage Vcp to an application terminal for the boot voltage Vb.

This embodiment is particularly preferable in a case where the switching output stage SWO employs a diode rectification scheme,

Note that the charge pump 1F is not expected to keep the boot voltage Vb at a voltage value higher than the input voltage Vin all the time; it has only to have a current capacity sufficient to raise the boot voltage Vb slightly when it drops. Accordingly, as the charge pump 1F can be shared, for example, an existing charge pump provided to maintain the boot voltage Vb while the switching output stage SWO is being driven at a duty of 100%.

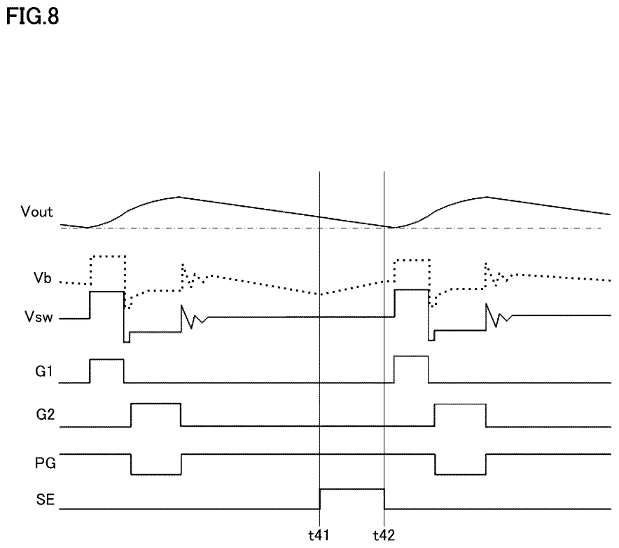

FIG. 8 is a diagram showing the switching operation in the third embodiment, depicting, like FIG. 6 referred to previously, from top down, the output voltage Vout, the switching voltage Vsw (solid line) and the boot voltage Vb (broken line), the gate driving signals G1, G2, and PG, and the reboot control signal SE. This diagram too shows intermittent switching operation wave forms in a light-load condition.

In the driving suspension period of the switching output stage SWO (G1=G2=L), the boot voltage Vb falls and when at time t41 the difference (Vb−Vsw) between the boot voltage Vb and the switching voltage Vsw becomes lower than the lower-limit detection value, the reboot control signal SE rises to high level. Now, the charge pump 1F is driven and thus, as observed between times t41 and t42, the capacitor C3 is charged and the boot voltage Vb rises. It is thus possible to raise the boot voltage Vb sufficiently before a turn-on of the output element M1.

Note that, between times t41 and t42, unlike in the second embodiment described previously (FIG. 6, between times t31 to t32), the synchronous-rectification element M2 is not turned on to charge the capacitor C3. It is thus possible to further reduce the fall in the output voltage Vout than in the second embodiment (FIG. 6) described previously.

### Switching Power Supply (Fourth Embodiment)

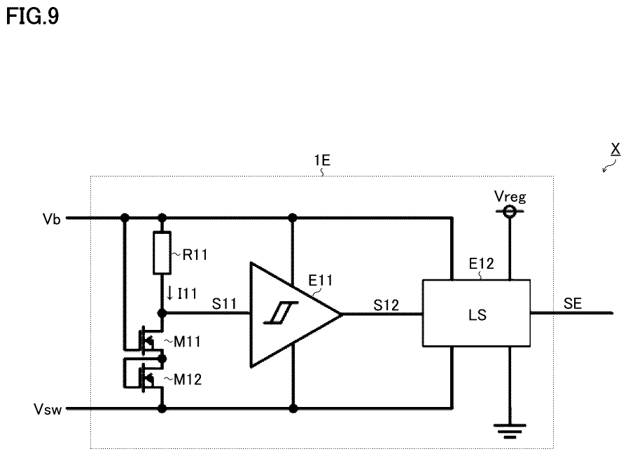

FIG. 9 is a diagram showing a switching power supply X according to a fourth embodiment (as a common configuration example to be compared with the fifth embodiment described later). In the switching power supply X of this embodiment, a boot voltage detection circuit 1E includes a Schmitt buffer E11, a level shifter E12, transistors M11 and M12 (e.g., both NMOSFETs), and a resistor R11.

The first terminal of the resistor R11 and the gate of the transistor M11 are both connected to an application terminal for the boot voltage Vb. The second terminal of the resistor R11 and the drain of the transistor M11 are both connected to the input terminal of the Schmitt buffer E11 (i.e., an application terminal for a node voltage S11). The source of the transistor M11 is connected to the gate and the drain of the transistor M12. The source of the transistor M12 is connected to an application terminal for the switching voltage Vsw.

If the difference (Vb−Vsw) between the boot voltage Vb and the switching voltage Vsw is higher than the lower-limit detection value 2×Vgs (where Vgs represents the on threshold value of each of the transistors M11 and M12), the transistors M11 and M12 are both on. Thus, an internal current I11 passes across a current path leading from the application terminal for the boot voltage Vb via the resistor R11 and the transistors M11 and M12 to the application terminal for the switching voltage Vsw. As a result, the node voltage S11 is at low level. By contrast, if the difference (Vb−Vsw) between the boot voltage Vb and the switching voltage Vsw is lower than the lower-limit detection value 2×Vgs, the transistors M11 and M12 are both off. Thus, no internal current I11 passes, and hence the node voltage S11 is at high level (=Vb).

The Schmitt buffer E11 is fed with the node voltage S11 to output a node voltage S12. for example, the node voltage S12 is at high level (=Vb) if the node voltage S11 is at high level (=Vb), and is at low level (=Vsw) if the node voltage S11 is at low level (=Vsw). The Schmitt buffer E11 can be given hysteresis characteristics.

The level shifter E12 shifts the level of the node voltage S12 to generate the reboot control signal SE. For example, the reboot control signal SE is at high level (=Vreg) if the node voltage S12 is at high level (=Vb), and is at low level (=AGND) if the node voltage S12 is at low level (=Vsw).

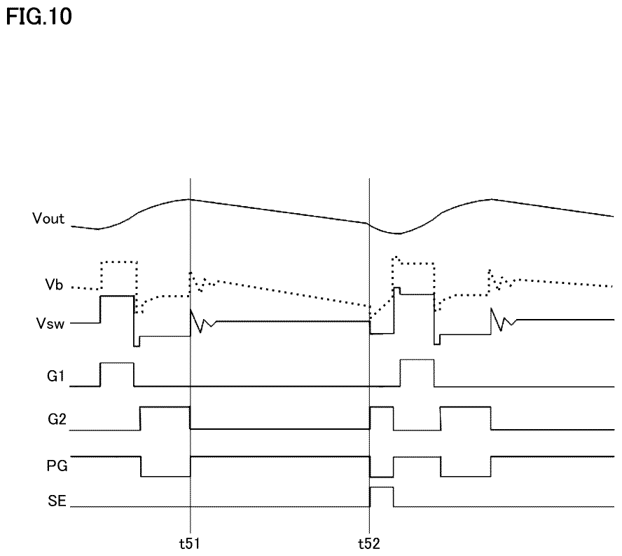

FIG. 10 is a diagram showing the switching operation in the fourth embodiment, depicting, like FIG. 6 referred to previously, from top down, the output voltage Vout, the switching voltage Vsw (solid line) and the boot voltage Vb (broken line), the gate driving signals G1, G2, and PG, and the reboot control signal SE. This diagram too shows intermittent switching operation wave forms in a light-load condition.

In the switching power supply X of this embodiment, while the difference (Vb−Vsw) between the boot voltage Vb and the switching voltage Vsw is higher than the lower-limit detection value, the internal current I11 in the boot voltage detection circuit 1E keeps passing from the application terminal for the boot voltage Vb to the application terminal for the switching voltage Vsw.

Thus, in the driving suspension period of the switching output stage SWO (i.e., between times t51 to t52), the boot voltage Vb has a high falling speed.

Presented below is a novel embodiment devised to solve the above problem.

### Switching Power Supply (Fifth Embodiment)

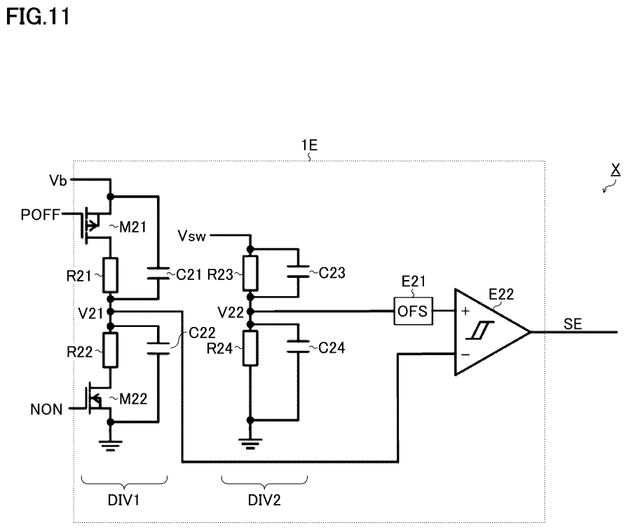

FIG. 11 is a diagram showing a switching power supply X according to a fifth embodiment. In the switching power supply X of this embodiment, the boot voltage detection circuit 1E includes voltage division circuits DIV1 and DIV2, an offset adding circuit E21, and a comparator E22.

The voltage division circuit DIV1 divides the boot voltage Vb to produce a division voltage V21. The voltage division ratio in the voltage division circuit DIV1 can be ½. In what is shown in the diagram, the voltage division circuit DIV1 includes a transistor M21 (corresponding to a first switch; e.g., a PMOSFET), a transistor M22 (corresponding to a second switch; e.g., an NMOSFET), resistors R21 and R22, and capacitors C21 and C22.

The source of the transistor M21 and the first terminal of the capacitor C21 are both connected to an application terminal for the boot voltage Vb. The drain of the transistor M21 is connected to the first terminal of the resistor R21. The second terminals of the resistor R21 and the capacitor C21 and the first terminals of the resistor R22 and the capacitor C22 are all connected to an application terminal for the division voltage V21. The second terminal of the resistor R22 is connected to the drain of the transistor M22. The source of the transistor M22 and the second terminal of the capacitor C22 are both connected to a ground terminal (e.g., the analog-system ground terminal AGND).

The gate of the transistor M21 is connected to an application terminal for a gate driving signal POFF. Accordingly, the transistor M21 is on if the gate driving signal POFF is at low level, and is off if the gate driving signal POFF is at high level.

The gate of the transistor M22 is connected to an application terminal for a gate driving signal NON. Accordingly, the transistor M22 is on if the gate driving signal NON is at high level, and is off if the gate driving signal NON is at low level.

The voltage division circuit DIV2 divides the switching voltage Vsw to produce a division voltage V22. The voltage division ratio in the voltage division circuit DIV2 can be ½. In what is shown in the diagram, the voltage division circuit DIV2 includes resistors R23 and R24 and capacitors C23 and C24. The capacitors C23 and C24 can be omitted.

The first terminals of the resistor R23 and the capacitor C23 are both connected to an application terminal for the switching voltage Vsw. The second terminals of the resistor R23 and the capacitor C23 and the first terminals of the resistor R24 and the capacitor C24 are all connected to an application terminal for the division voltage V22. The second terminals of the resistor R24 and the capacitor C24 are both connected to a ground terminal (e.g., the analog-system ground terminal AGND).

The offset adding circuit E21 offsets the division voltage V22 and feeds the result to the non-inverting input terminal (+) of the comparator E22. The offset adding circuit E21 can instead offset the division voltage V21 and output the result to the inverting input terminal (−) of the comparator E22. Note that, if the offset added to the division voltage V22 is positive, the offset added to the division voltage V21 is negative.

The comparator E22 compares the division voltage V21, which is fed to its inverting input terminal (−), with the division voltage V22 having undergone offsetting, which is fed to its non-inverting input terminal (+), to produce the reboot control signal SE. For example, the reboot control signal SE is at low level if the division voltage V21 is higher than the division voltage V22 after offsetting, and is at high level if the division voltage V21 is lower than the division voltage V22 after offsetting.

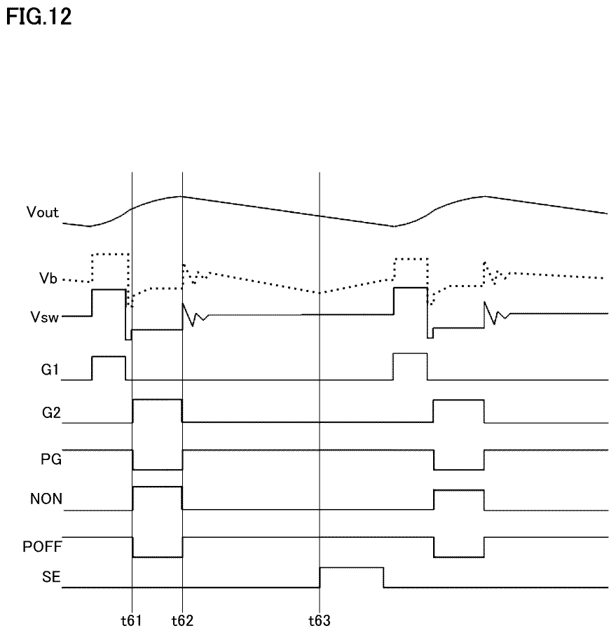

FIG. 12 is a diagram showing the switching operation in the fifth embodiment, depicting, from top down, the output voltage Vout, the switching voltage Vsw (solid line) and the boot voltage Vb (broken line), the gate driving signals G1, G2, PG, NON, and POFF, and the reboot control signal SE. This diagram too shows intermittent switching operation wave forms in a light-load condition.

As observed between times t61 and 162, with the output element M1 off (G1=L) and the synchronous-rectification clement M2 on (G2=H), the gate driving signal NON is at high level and the gate driving signal POFF is at low level. Thus, the transistors M21 and M22 are both on. As a result, the voltage division circuit DIV1 produces the division voltage V21 through resistance voltage division of the boot voltage Vb with the resistors R21 and R22. Thus, the period between times t61 to t62 corresponds to a resistance voltage division period for the boot voltage Vb.

On the other hand, as observed between times t62 and t63, with the output element M1 and the synchronous-rectification clement M2 both off (G1=G2=L), the gate driving signal NON is at low level and the gate driving signal POFF is at high level. Thus, the transistors M21 and M22 are both off. As a result, the voltage division circuit DIV1 produces the division voltage V21 through capacitance voltage division of the boot voltage Vb with the capacitors C21 and C22. Thus, the period between times t62 and t63 corresponds to a capacitance voltage division period for the boot voltage Vb.

In the capacitance voltage division period (between times t62 and t63) described above, no current path exists within the voltage division circuit DIV1 that leads from the application terminal for the boot voltage Vb to the application terminal for the switching voltage Vsw. This helps keep low the falling speed of the boot voltage Vb in the driving suspension period of the switching output stage SWO (i.e., between times t62 and t62).

Simply reducing the falling speed of the boot voltage Vb can be achieved by sensing the boot voltage Vb always through capacitance voltage division. Inconveniently, this configuration has a drawback: if noise or the like causes a deviation in the voltage division ratio in the voltage division circuit DIV1, there is no way to eliminate it.

On the other hand, in a configuration where, as described above, the capacitance voltage division period (between times t62 and t63) is preceded by a resistance voltage division period (between times t61 and t62), the voltage division ratio in the voltage division circuit DIV1 can be re-set (refreshed) every time the switching output stage SWO is driven to switch. Thus, even if noise or the like causes a deviation in the voltage division ratio in the voltage division circuit DIV, it can be eliminated promptly.

### Overview

To follow is an overview of the various embodiments described above.

For example, according to one aspect of what is disclosed herein, a semiconductor device includes: a first driver configured to drive an output element constituting a switching output stage; at least a part of a bootstrap circuit configured to generate a boot voltage higher than a switching voltage output from the switching output stage and feed the boot voltage to the first driver; and a boot voltage detection circuit configured to charge the boot voltage on sensing, with the output element off, the difference between the boot voltage and the switching voltage becoming lower than a lower-limit detection value. The boot voltage detection circuit senses the boot voltage through resistance voltage division if a rectification element constituting together with the output element the switching output stage is on, and senses the boot voltage through capacitance voltage division if the rectification element is off. (A first configuration.)

In the semiconductor device of the first configuration described above, the rectification element can be a synchronous-rectification element configured to be driven complementarily with the output element. (A second configuration.)

The semiconductor device of the second configuration described above can further include: a second driver configured to drive the synchronous-rectification element; and a control circuit configured to drive the output element and the synchronous-rectification element complementarily and to turn off the synchronous-rectification clement on detecting, with the output element off and the synchronous-rectification element on, the switching voltage becoming higher than a zero-cross detection value. (A third configuration.)

In the semiconductor device of the second or third configuration described above, the boot voltage detection circuit can turn on the synchronous-rectification element on detecting the difference between the boot voltage and the switching voltage becoming lower than the lower-limit detection value. (A fourth configuration.)

In the semiconductor device of any of the first to fourth configurations described above, the boot voltage detection circuit can apply to an application terminal for the boot voltage a boosted voltage higher than the input voltage fed to the switching output stage on detecting the difference between the boot voltage and the switching voltage becoming lower than the lower-limit detection value. (A fifth configuration.)

In the semiconductor device of any of the first to fifth configurations described above, the boot voltage detection circuit can include: a first voltage division circuit configured to divide the boot voltage to produce a first division voltage; a second voltage division circuit configured to divide the switching voltage to produce a second division voltage; and a comparator configured to compare the first and second division voltages with each other. (A sixth configuration.)

In the semiconductor device of the sixth configuration described above, the first voltage division circuit can include a first switch, a second switch, a first resistor, a second resistor, a first capacitor, and a second capacitor. The first terminal of the first switch and the first terminal of the first capacitor can both be connected to an application terminal for the boot voltage. The second terminal of the first switch can be connected to the first terminal of the first resistor. The second terminal of the first resistor, the second terminal of the first capacitor, the first terminal of the second resistor, and the first terminal of the second capacitor can all be connected to an application terminal for the first division voltage. The second terminal of the second resistor can be connected to the first terminal of the second switch. The second terminal of the second switch and the second terminal of the second capacitor can all be connected to a ground terminal. (A seventh configuration.)

In the semiconductor device of the sixth or seventh configuration described above, the second voltage division circuit can include a third resistor, a fourth resistor, a third capacitor, and a fourth capacitor. The first terminal of the third resistor and the first terminal of the third capacitor can both be connected to an application terminal for the switching voltage. The second terminal of the third resistor, the second terminal of the third capacitor, the first terminal of the fourth resistor, and the first terminal of the fourth capacitor can all be connected to an application terminal for the second division voltage. The second terminal of the fourth resistor and the second terminal of the fourth capacitor can both be connected to a ground terminal. (An eighth configuration.)

In the semiconductor device of any of the sixth to eighth configurations described above, the boot voltage detection circuit can further include an offset adding circuit configured to offset the first or second division voltage to feed the comparator with the first or second division voltage having undergone offsetting. (A ninth configuration.)

For example, according to another aspect of what is disclosed herein, a switching power supply includes the semiconductor device according to any of the first to ninth configurations described above, and generates from an input voltage a desired output voltage by driving the switching output stage. (A tenth configuration.)

According to the present disclosure it is possible to provide a semiconductor device that can prevent a fall of the boot voltage generated by a bootstrap circuit, and to provide a switching power supply that employs such a semiconductor device.

### OTHER MODIFICATION EXAMPLES

The various technical features disclosed herein may be implemented in any manners other than as in the embodiments described above, and allow for many modifications without departure from the spirit of their technical ingenuity. That is, the embodiments described above should be understood to be in every aspect illustrative and not restrictive, and the technical scope of the present disclosure is defined not by the description of the embodiments given above but by the appended claims and should be understood to encompass any modifications within a scope and sense equivalent to those claims.

1. A semiconductor device comprising:
a first driver configured to drive an output element constituting a switching output stage;
at least a part of a bootstrap circuit configured to generate a boot voltage higher than a switching voltage output from the switching output stage and feed the boot voltage to the first driver; and
a boot voltage detection circuit configured to charge the boot voltage on sensing, with the output element off, a difference between the boot voltage and the switching voltage becoming lower than a lower-limit detection value,
wherein
the boot voltage detection circuit
senses the boot voltage through resistance voltage division if a rectification element constituting together with the output element the switching output stage is on and
senses the boot voltage through capacitance voltage division if the rectification element is off.

2. The semiconductor device according to claim 1, wherein
the rectification element is a synchronous-rectification element configured to be driven complementarily with the output element.

3. The semiconductor device according to claim 2, further comprising:
a second driver configured to drive the synchronous-rectification element; and
a control circuit configured
to drive the output element and the synchronous-rectification element complementarily and
to turn off the synchronous-rectification element on detecting, with the output element off and the synchronous-rectification element on, the switching voltage becoming higher than a zero-cross detection value.

4. The semiconductor device according to claim 2, wherein
the boot voltage detection circuit turns on the synchronous-rectification element on detecting the difference between the boot voltage and the switching voltage becoming lower than the lower-limit detection value.

5. The semiconductor device according to claim 1, wherein
the boot voltage detection circuit applies to an application terminal for the boot voltage a boosted voltage higher than an input voltage fed to the switching output stage on detecting the difference between the boot voltage and the switching voltage becoming lower than the lower-limit detection value.

6. The semiconductor device according to claim 1, wherein
the boot voltage detection circuit includes:
a first voltage division circuit configured to divide the boot voltage to produce a first division voltage;
a second voltage division circuit configured to divide the switching voltage to produce a second division voltage; and
a comparator configured to compare the first and second division voltages with each other.

7. The semiconductor device according to claim 6, wherein
the first voltage division circuit includes a first switch, a second switch, a first resistor, a second resistor, a first capacitor, and a second capacitor,
a first terminal of the first switch and a first terminal of the first capacitor are both connected to an application terminal for the boot voltage,
a second terminal of the first switch is connected to a first terminal of the first resistor,
a second terminal of the first resistor, a second terminal of the first capacitor, a first terminal of the second resistor, and a first terminal of the second capacitor are all connected to an application terminal for the first division voltage,
a second terminal of the second resistor is connected to a first terminal of the second switch, and
a second terminal of the second switch and a second terminal of the second capacitor are all connected to a ground terminal.

8. The semiconductor device according to claim 6, wherein
the second voltage division circuit includes a third resistor, a fourth resistor, a third capacitor, and a fourth capacitor,
a first terminal of the third resistor and a first terminal of the third capacitor are both connected to an application terminal for the switching voltage,
a second terminal of the third resistor, a second terminal of the third capacitor, a first terminal of the fourth resistor, and a first terminal of the fourth capacitor are all connected to an application terminal for the second division voltage, and
a second terminal of the fourth resistor and a second terminal of the fourth capacitor are both connected to a ground terminal.

9. The semiconductor device according to claim 6, wherein
the boot voltage detection circuit further includes an offset adding circuit configured to offset the first or second division voltage to feed the comparator with the first or second division voltage having undergone offsetting.

10. A switching power supply comprising the semiconductor device according to claim 1, the switching power supply generating from an input voltage a desired output voltage by driving the switching output stage.
